(19) United States
(12) Patent Application Publication
(10) Pub. No.: US 2023/0328865 A1
(43) Pub. Date: Oct. 12, 2023

(54) DETERMINING AN ORDER FOR REPRODUCING SONGS BASED ON DIFFERENCES BETWEEN LIGHT SCRIPTS

(71) Applicant: SIGNIFY HOLDING B.V., EINDHOVEN (NL)

(72) Inventors: DZMITRY VIKTOROVICH ALIAKSEYEU, EINDHOVEN (NL); BERENT WILLEM MEERBEEK, VELDHOVEN (NL); GERHARDUS ENGBERTUS MEKENKAMP, VALKENSWAARD (NL)

(21) Appl. No.: 18/023,026

(22) PCT Filed: Aug. 9, 2021
(86) PCT No.: PCT/EP2021/072164

§ 371 Date: Feb. 24, 2023

(30) Foreign Application Priority Data
Aug. 26, 2020 (EP) 20192914.8

(51) Int. Cl. H05B 47/165; H05B 47/155

(52) U.S. Cl. CPC H05B 47/165; H05B 47/155

(57) ABSTRACT

A system for determining an order for reproducing light very dynamic scripts is configured to select at least three songs from a collection of songs and obtain at least three light scripts (51-58) for the at least three songs. The system is further configured to determine differences between the at least three light scripts, determine the order (63) for reproducing the at least three songs and the at least three light scripts based on the differences, and control the lighting device to render the light settings specified in the at least three light scripts according to the order, communicate the order to a further system, and/or store the order in a memory.

### FIELD OF THE INVENTION

The invention relates to a system for determining an order for reproducing light scripts, a lighting device being controlled to render light settings specified in said light scripts according to said order.

The invention further relates to a method of determining an order for reproducing light scripts, a lighting device being controlled to render light settings specified in said light scripts according to said order.

The invention also relates to a computer program product enabling a computer system to perform such a method.

### BACKGROUND OF THE INVENTION

Philips' Hue Entertainment and Hue Sync have become very popular among owners of Philips Hue lights. Philips Hue Sync enables the rendering of light effects based on the content that is played on a computer. Initially, Hue Sync was only available as an application for PCs. An HDMI module called the Hue Play HDMI Sync Box was later added to the Hue entertainment portfolio. This device addresses one of the main limitations of Hue Sync and aims at streaming and gaming devices connected to the TV. It makes use of the same principle of an entertainment area and the same mechanisms to transport information. This device is in principle a HDMI splitter which is placed between any HDMI device and a TV.

A dynamic lighting system can dramatically influence the experience and impression of audio-visual material, e.g. when the colors sent to the lights match what would be seen in the composed environment around the screen. However, a dynamic lighting system cannot only be used to enhance screen content, but also to enhance the experience of listening to music, e.g. by using a software algorithm to analyze an audio stream in real-time and create light effects based on certain audio characteristics such as intensity and frequency bands.

An alternative approach is to preprocess music and extract relevant meta data and translate this to a light script specifying light effects. Some of the streaming services offer such metadata. For example, Spotify has a meta data for each song, that includes different audio properties and can be accessed via the Spotify API. The advantage of using metadata for light effects creation is that it does not require access to the audio stream and allows analysis of the data of the complete song instead of relying on the real-time data.

The latter approach also makes it easier to find songs that fit a certain light scene, e.g. in the manner disclosed in WO 2019/238834 A1. Amongst others, WO 2019/238834 A1 describes composing a playlist of songs with the same duration as a light scene and selecting relaxing music tracks for a sunset light scene. Although selecting songs that fit a certain light scene results in a coherent light and music experience, it also limits the song selection significantly, which is not always desired by users.

### SUMMARY OF THE INVENTION

It is a first object of the invention to provide a system, which can be used to provide a coherent light and music experience without significantly limiting song selection.

It is a second object of the invention to provide a method, which can be used to provide a coherent light and music experience without significantly limiting song selection.

In a first aspect of the invention, a system for determining an order for reproducing light scripts, a lighting device being controlled to render light settings specified in said light scripts according to said order, comprises at least one processor configured to select at least three songs from a collection of songs, obtain at least three light scripts for said at least three songs, determine differences between said at least three light scripts, determine said order for reproducing said at least three songs and said at least three light scripts based on said differences, and control said lighting device to render said light settings specified in said at least three light scripts according to said order, communicate said order to a further system, and/or store said order in a memory.

If a user selects a playlist and the system then obtains light scripts corresponding to the songs in this playlist and reproduces these songs and these light scripts, this may lead to a continuously changing dynamics level, brightness and/or colors, resulting in a chaotic and unpleasant experience, e.g. if the playlist contains songs of different genres. By analyzing the light scripts obtained for the songs in the playlist and then adapting the order of the songs in the playlist to ensure suitable light transitions, a coherent light and music experience may be provided without significantly limiting song selection. Suitable light transitions may be ensured by limiting or minimizing differences in dynamicity level, brightness and/or color palette between light scripts of consecutive songs. Additionally, light transitions in between songs may be adapted and any user settings (e.g. desired level of dynamicity) may be considered.

Said differences may be determined by determining differences between said light settings specified in said at least three light scripts, e.g. by performing an analysis on said light settings specified in said at least three light scripts. Alternatively, said differences may be determined by determining differences between metadata used to create said at least three light scripts, e.g. using knowledge on how light scripts are created using this metadata.

Said at least one processor may be configured to determine a transition between two of said at least three light scripts and control said lighting device to render said transition between said two light scripts, said two light scripts being ordered consecutively in said order. This may be used if the differences between the two consecutive light scripts are still relatively large, despite the order being determined based on the differences, to make the transition between the two songs and light scripts smoother. For example, light settings at the end of a song and/or at the start of the next song may be adapted and/or transitional light settings may be rendered during a pause in between songs.

Said at least one processor may be configured to adjust at least one of two of said at least three light scripts to reduce differences between said two light scripts, said two light scripts being ordered consecutively in said order. This may be used if the differences between the two consecutive light scripts are still relatively large, despite the order being determined based on the differences, to make the transition between the two songs and light scripts smoother.

Said at least one processor may be configured to determine a plurality of orders for reproducing said at least three songs and said at least three light scripts, determine for each of said plurality of orders a sum of differences between each pair of consecutive light scripts in said respective order, and select an order with from said plurality of orders based on said sums. For example, an order that minimizes the sum of differences between consecutive light scripts may be selected. Optionally, differences between each two consecutive light scripts may also be required to stay below a threshold.

Said at least one processor may be configured to determine a plurality of orders for reproducing said at least three songs and said at least three light scripts, differences between each pair of consecutive light scripts staying below a threshold in each of said plurality of orders, and selecting one of said plurality of orders. In this way, an order is selected in which differences between consecutive light scripts stay below the threshold. An order may then be randomly selected from the determined plurality of orders, for example.

Said at least one processor may be configured to determine an initial order for reproducing said at least three songs and replace said initial order with said order. As a first example, if all songs from an album are selected, then these songs will have an initial order as used on the album, which is then replaced by the new order. As a second example, music streaming services offer manually created and automatically generated playlists which have an initial order, which is then replaced by the new order. Such a reordered automatically generated playlist may, for example, follow a manually created or automatically generated playlist which is not reordered.

As an example of the latter, Spotify offers a feature called “Spotify Radio” which creates a collection of songs based on any artist, album, playlist, or song of the user's choice. Related to this, Spotify also has a feature which, if the user creates a playlist and the playlist reaches the end, it will automatically find songs that fit the playlist and will continue playing and it will continue extending the playlist as long as the user continues to listen. With these features, if Spotify for example extends the list by two or more songs, these two or more songs may be reordered (e.g. in case of only two songs, the last song that was played may be used to decide which of these two should go first), and when Spotify adds two more, these two more songs may be reordered, and so on. Thus, in this case, multiple smaller playlists are reordered.

Said at least one processor may be configured to determine said order for reproducing said at least three songs and said at least three light scripts further based on said initial order. This is beneficial for a hybrid shuffle mode in which the user would like the order to stay as close to the original/initial order as possible, but still get a coherent light and music experience.

Said at least one processor may be configured to determine a plurality of orders for reproducing said at least three songs and said at least three light scripts, determine for each of said plurality of orders a quantity of consecutive pairs of songs of said initial order included in said respective order, and select an order from said plurality of orders based on said quantities. For example, an order may be selected in which as many consecutive songs (i.e. the same song is played next after a song) as possible are the same as in the initial order.

Said at least one processor may be configured to determine said order for reproducing said at least three songs and said at least three light scripts in dependence on a shuffle mode being active. If neither a regular shuffle mode nor a hybrid shuffle mode is active, the user may not expect and not appreciate an initial order being replaced with a new order. By checking whether a shuffle mode is active, an unexpected and undesired re-ordering may be prevented.

Said at least one processor may be configured to determine said differences by performing an analysis on dynamicity settings, brightness settings and/or color settings of said light settings specified in said at least three light scripts, for example.

Said at least one processor may be configured to receive user input indicating a desired range of dynamicity settings, a desired range of brightness settings and/or a desired range of color settings, said at least three light scripts having light settings falling in said one or more desired ranges, and/or user input indicating a pattern in dynamicity settings, said order conforming with said specified pattern. In certain situations, the user may want to limit song selection himself or may want to influence which light effects are determined based on music metadata. The user may also want to specify a pattern in dynamicity settings in dependence on the event that he has planned, e.g. start the evening with static light effects and end with very dynamic light effects.

Said at least one processor may be configured to determine said differences by determining differences between average light settings specified in said at least three light scripts. Although a rough transition between the light effects at the end of a light script and the light effects at the start of the next light script is not optimal, it is typically even less desirable to have a substantial change in the average light settings, e.g. overall dynamicity level, between light scripts.

In a second aspect of the invention, a method of determining an order for reproducing light scripts, a lighting device being controlled to render light settings specified in said light scripts according to said order, comprises selecting at least three songs from a collection of songs, obtaining at least three light scripts for said at least three songs, determining differences between said at least three light scripts, determining said order for reproducing said at least three songs and said at least three light scripts based on said differences, and controlling said lighting device to render said light settings specified in said at least three light scripts according to said order, communicating said order to a further system, and/or storing said order in a memory. Said method may be performed by software running on a programmable device. This software may be provided as a computer program product.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations for determining an order for reproducing light scripts, a lighting device being controlled to render light settings specified in said light scripts according to said order.

The executable operations comprise selecting at least three songs from a collection of songs, obtaining at least three light scripts for said at least three songs, determining differences between said at least three light scripts, determining said order for reproducing said at least three songs and said at least three light scripts based on said differences, and controlling said lighting device to render said light settings specified in said at least three light scripts according to said order, communicating said order to a further system, and/or storing said order in a memory.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java(™), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of a first embodiment of the system;

FIG. 2 is a block diagram of a second embodiment of the system;

FIG. 3 is a flow diagram of a first embodiment of the method;

FIG. 4 is a flow diagram of a second embodiment of the method;

FIG. 5 is a flow diagram of a third embodiment of the method;

FIG. 6 is a flow diagram of a fourth embodiment of the method;

FIG. 7 shows a first example of replacing an initial order;

FIG. 8 shows a second example of replacing an initial order;

FIG. 9 is a flow diagram of a fifth embodiment of the method;

FIG. 10 is a flow diagram of a sixth embodiment of the method; and

FIG. 11 is a block diagram of an exemplary data processing system for performing the method of the invention.

Corresponding elements in the drawings are denoted by the same reference numeral.

### DETAILED DESCRIPTION OF THE EMBODIMENTS

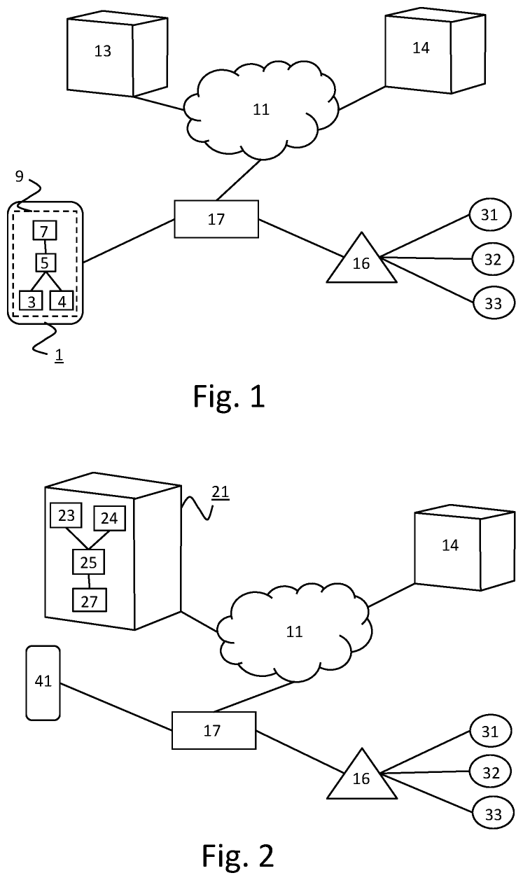

FIG. 1 shows a first embodiment of the system for determining an order for reproducing light scripts. In the example of FIG. 1, lighting devices 31-33 are controlled to render light settings specified in the light scripts according to this order. In this first embodiment, the system is a mobile device 1. Lighting devices 31-33 may be Philips Hue lamps, for example.

Mobile device 1 runs an app for playing back music, e.g. a music streaming service such as Spotify. This app or a different app running on the mobile device 1 determines the order for reproducing songs and the corresponding light scripts. In the embodiment of FIG. 1, the app that determines the order is able to control the lighting devices 31-33, e.g. via the local area network and the Internet 11 or via only the local area network. In the former case, the app may transmit commands for the lighting devices 31-33 to the Internet server 13 of a lighting company, which then transmits them to the lighting devices 31-33 via the local network, i.e. via a wireless LAN access point 17 and a (light) bridge 16. Alternatively, the app may control the lighting devices 31-33 via a digital assistant, e.g. Amazon Alexa.

In an alternative embodiment, the app that determines the order is not able to control the lighting devices 31-33 itself, but only able to communicate the order to another app or to a further system or to store them in a memory. In the embodiment of FIG. 1, the app that determines the order is also able to control playback of the songs, e.g. on the mobile device 1 itself or on an external speaker via Bluetooth. For example, the app may be able to playback the songs itself or may, via an Internet server 14 of a music streaming service or via a digital assistant like Amazon Alexa, direct another app, e.g. running on the mobile device 1, to playback the songs.

The lighting devices 31-33 communicate with the bridge 16, e.g. using Zigbee technology. The bridge 16 may be a Philips Hue bridge, for example. The mobile device 1 is able to control the lighting devices 31-33 via the wireless LAN access point 17 and the bridge 16, and optionally via the Internet server 13. The wireless LAN access point 17 is connected to the Internet 11. The Internet servers 13 and 14 are also connected to the Internet 11. Instead of single Internet servers, clusters of Internet servers may be used. These clusters may be part of one or more clouds.

The mobile device 1 comprises a transceiver 3, a transmitter 4, a processor 5, memory 7, and a display 9. The processor 5 is configured to select at least three songs from a collection of songs, e.g. via the Internet server 14, obtain at least three light scripts for the at least three songs, determine differences between the at least three light scripts, determine the order for reproducing the at least three songs and the at least three light scripts based on the differences, and control, via the transmitter 4, the lighting devices 31-33 to render the light settings specified in the at least three light scripts according to the order, communicate the order to a further system, e.g. Internet server 13, and/or store the order in the memory 7. The order for reproducing songs is also referred to as a playlist order.

The at least three light scripts specifying the light effects may be obtained from the Internet server 13 or may be created by the mobile device 1 based on metadata received from the Internet server 14. If the at least three light scripts are obtained from the Internet server 13, the Internet server 13 might then retrieve them from storage means or created them on-the-fly based on metadata received from the Internet server 14. A light script typically specifies multiple parameters for a plurality of time-based light effects. These parameters may include color, brightness, start time and/or duration.

The processor 5 may be configured to determine the differences between the at least three light scripts by performing an analysis on the light settings specified in the at least three light scripts. This will typically work independent of whether the light scripts are created manually or automatically. Alternatively, when light scripts are automatically created based on (e.g. Spotify) metadata, light scripts may be created based on analysis of specific parts of the metadata using knowledge on how light scripts are created using this metadata.

Even before creating a light script, the parameters of the metadata that are used to create the script may be determined. As a result, the order may be determined before the light scripts are determined. This approach may be more efficient. The scripts will still need to be created later, but this approach may reduce the waiting time when a user creates a playlist and clicks play. In order to determine the differences between light scripts, a dynamicity level of a light script may be determined for each light script. A dynamicity level typically represents how fast and substantial light effects change from a darker to a brighter color and vice versa in the light effects specified in the light script. The faster and larger the changes, the more dynamic the light effects in a light script are. Alternatively or additionally, an (average) brightness, and/or color palette may be determined for each light script.

The goal of determining the (new) order for reproducing the at least three songs and the at least three light scripts based on the differences is to limit or minimize the differences between light scripts of consecutive songs. Since the differences between values of multiple parameters characterizing a light script may be determined (e.g. dynamicity level, brightness and color palette) and differences between values of different parameters may be experienced differently by different users, user or system defined weights may be used to define the importance of each parameter (e.g. some users might prefer more smooth dynamics transitions, while others might prefer a more stable brightness or color palette).

Often, an initial order exists for a playlist and the songs in this playlist then have to be reordered. The simplest approach for this reordering is to minimize the differences between dynamicity level and other aspects of the light effects. This approach however might require considerable reshuffling of the playlist and might not be desired by a user. Whether or not the reordering of the playlist is done may depend on the playback settings the user has selected. If a user has selected regular (sequential) playback of the playlist, the reordering may be skipped. Possibly, the reordering only takes places when users select the shuffle mode in playback of the songs (instead of sequential order). In this case, the users want to have the songs played back in a non-sequential order and the dynamics of the light effect determine the shuffling order (instead of a random ordering).

The processor 5 may be configured to determine a transition between two of the at least three light scripts, which are ordered consecutively in the order, and control the lighting device to render the transition between the two light scripts. The transition may be rendered while the last part of the first song and/or the first part of the second song is being played and/or during a pause between the two songs. This helps mitigate the effect of larger differences between, e.g. average dynamicity level or brightness of, light scripts of consecutive songs. If one or more of the lighting devices 31-33 is a pixelated lighting device, e.g. a light strip, transitions may be implemented on a pixel level: while one set of pixels continues to render light effects, another set of pixels slowly ramps up (e.g. adjusts brightness, transits in color) as a “preparation” for the next song.

In the embodiment of the mobile device 1 shown in FIG. 1, the mobile device 1 comprises one processor 5. In an alternative embodiment, the mobile device 1 comprises multiple processors. The processor 5 of the mobile device 1 may be a general-purpose processor, e.g. from ARM or Qualcomm or an application-specific processor. The processor 5 of the mobile device 1 may run an Android or iOS operating system for example. The display 9 may comprise an LCD or OLED display panel, for example. The display 9 may be a touch screen, for example. The processor 5 may use this touch screen to provide a user interface, for example. The memory 7 may comprise one or more memory units. The memory 7 may comprise solid state memory, for example.

The receiver 3 and the transmitter 4 may use one or more wireless communication technologies, e.g. Wi-Fi (IEEE 802.11) for communicating with the wireless LAN access point 17, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 3 and the transmitter 4 are combined into a transceiver. The mobile device 1 may comprise other components typical for a mobile device such as a battery and a power connector. The invention may be implemented using a computer program running on one or more processors.

In the embodiment of FIG. 1, the lighting devices 31-33 are controlled by the mobile device 1 via the bridge 16. In an alternative embodiment, one or more of the lighting devices 31-33 are controlled by the mobile device 1 without a bridge, e.g. directly via Bluetooth or via the wireless LAN access point 17. Optionally, the lighting devices 31-33 are controlled via the cloud, e.g. via Internet server 13. The lighting devices 31-33 may be capable of receiving and transmitting Wi-Fi signals, for example.

FIG. 2 shows a second embodiment of the system for determining an order for reproducing light scripts. In this second embodiment, the system is a computer 21. The computer 21 is connected to the Internet 11 and acts as a server. The computer 21 may be operated by a lighting company, for example. In the embodiment of FIG. 2, the computer 21 is able to control the lighting devices 31-33 via the wireless LAN access point 17 and the bridge 16 and able to communicate with the Internet server 14 of a music streaming service.

The computer 21 comprises a receiver 23, a transmitter 24, a processor 25, and storage means 27. The processor 25 is configured to select at least three songs from a collection of songs, e.g. via the Internet server 14, obtain at least three light scripts for the at least three songs, e.g. retrieved from the memory 27 or created on-the-fly, determine differences between the at least three light scripts, determine the order for reproducing the at least three songs and the at least three light scripts based on the differences, and control, via the transmitter 24, the lighting devices 31-33 to render the light settings specified in the at least three light scripts according to the order, communicate the order to a further system, e.g. mobile device 41, and/or store the order in the memory 27.

The processor 25 may be configured to determine the differences between the at least three light scripts by performing an analysis on the light settings specified in the at least three light scripts.

The processor 25 may further be configured to control the playback of the songs, e.g. via the Internet server 14. The songs may be played back via the mobile device 41 or via a smart speaker (not shown), for example. A user may be able to provide user input to the computer 21 via the mobile device 41, e.g. indicating a desired range of dynamicity settings, a desired range of brightness settings and/or a desired range of color settings.

In the embodiment of FIG. 2, everything happens in the cloud. On the user side, there is only user control: selecting a song, playlist, pause, play, etc. It does not matter what device is used for user control since all commands go directly to the cloud. In the example of FIG. 2, two “clouds” may be distinguished: the computer 21 is part of the cloud of a lighting company, e.g. Signify, and Internet server 14 is part of the cloud of a music streaming service, e.g. Spotify.

In an implementation, when a user sends a command to the computer 21 to “start playing light effects”, e.g. using mobile device 41, the computer 21 contacts Internet server 14 and asks for the currently playing song, metadata, and the playlist. Then the computer 21 obtains a first light script and streams it to the bridge 16 while continuing to receive events from the Internet server 14 for syncing music and light effects.

In this implementation, the computer 21 creates or retrieves (in case of manual light scripts) light scripts for all songs from the playlist to compare them (to reduce the delay on the user side, the computer 21 may ignore the first song and start playing light effects without analysis of the whole playlist and determine the order only for the next songs). After analysis, the new order of songs is communicated to the Internet server 14, which then adjusts the order of songs.

In the embodiment of the computer 21 shown in FIG. 2, the computer 21 comprises one processor 25. In an alternative embodiment, the computer 21 comprises multiple processors. The processor 25 of the computer 21 may be a general-purpose processor, e.g. from Intel or AMD, or an application-specific processor. The processor 25 of the computer 21 may run a Windows or Unix-based operating system for example. The storage means 27 may comprise one or more memory units. The storage means 27 may comprise one or more hard disks and/or solid-state memory, for example. The storage means 27 may be used to store an operating system, applications and application data, for example.

The receiver 23 and the transmitter 24 may use one or more wired and/or wireless communication technologies such as Ethernet and/or Wi-Fi (IEEE 802.11) to communicate with the wireless LAN access point 17, for example. In an alternative embodiment, multiple receivers and/or multiple transmitters are used instead of a single receiver and a single transmitter. In the embodiment shown in FIG. 2, a separate receiver and a separate transmitter are used. In an alternative embodiment, the receiver 23 and the transmitter 24 are combined into a transceiver. The computer 21 may comprise other components typical for a computer such as a power connector. The invention may be implemented using a computer program running on one or more processors.

In the embodiment of FIG. 2, the computer 21 receives data from and transmits data to the lighting devices 31-33 via the bridge 16. In an alternative embodiment, the computer 21 receives data from and transmits data to one or more of the lighting devices 31-33 without a bridge.

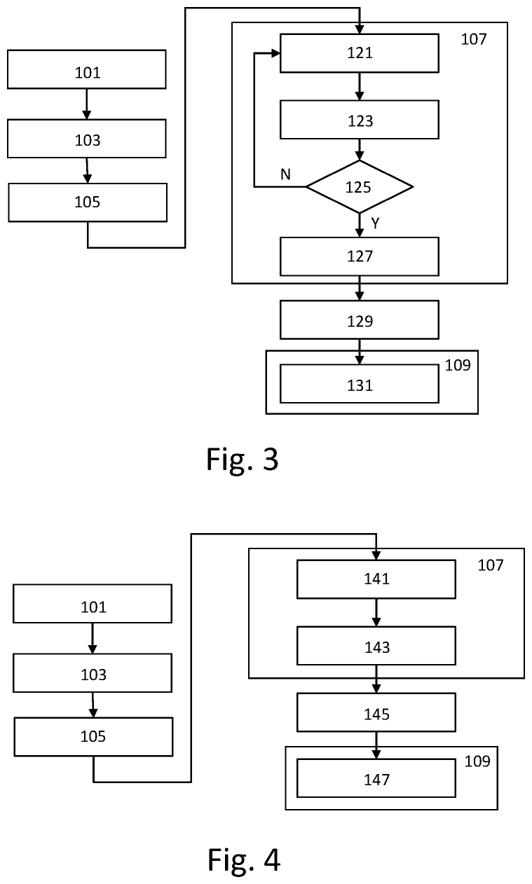

A first embodiment of the method of determining an order for reproducing light scripts is shown in FIG. 3. A step 101 comprises selecting at least three songs from a collection of songs. A step 103 comprises obtaining at least three light scripts for the at least three songs. A step 105 comprises performing an analysis on the light settings specified in the at least three light scripts to determine differences between the light settings specified in the at least three light scripts.

Next, a step 107 comprises determining the order for reproducing the at least three songs and the at least three light scripts based on the differences determined in step 105. In the embodiment of FIG. 3, step 107 is implemented by steps 121-127. In the first iteration of step 121, step 121 comprises determining a first candidate order for reproducing the at least three songs and the at least three light scripts. Step 123 comprises determining, based on the differences determined in step 105, a sum of the differences between light settings of each pair of consecutive light scripts in the order determined in step 121. For example, a dynamicity level may increase by 5% between a first and a second song and decrease by 10% between the second song and a third song, resulting in a sum of 15%.

Step 125 comprises determining whether all (suitable) candidate orders have been determined. If not, steps 121-125 are repeated for the next candidate order. If it is determined in step 125 that all (suitable) candidate orders have been determined, step 127 is performed next. Step 127 comprises selecting one of the orders determined in step 121 based on the sums determined in step 123, and specifically comprises selecting the order with the smallest sum.

A step 129 comprises determining a transition between two of the at least three light scripts which are ordered consecutively in the order and possibly one or more further transitions between other consecutive light scripts. A step 109 comprises controlling the lighting device to render the light settings specified in the at least three light scripts according to the order, communicating the order to a further system, and/or storing the order in a memory. In the embodiment of FIG. 3, step 109 comprises controlling the lighting device to render the light settings specified in the at least three light scripts according to the order determined in step 107 and the transition(s) determined in step 129.

As an example of such a transition, if a currently playing song on average results in light effects with low brightness and has an ending that results in even lower brightness while the next song starts from an upbeat that leads to bright light effects, the brightness of the light effects of the current song might be slightly reduced at the end to reduce the contrast caused by moving to much brighter effects for the upcoming song.

Whether a transition is created between songs may depend on whether a song was skipped or added by the user in the order determined in step 107. If a song is skipped, the transition likely needs to be adjusted to reduce the potential impact of increased contrast between the current effects and upcoming effects defined by the next song.

A second embodiment of the method of determining an order for reproducing light scripts is shown in FIG. 4. In the embodiment of FIG. 4, compared to the embodiment of FIG. 3, step 107 is implemented by steps 141-143 instead of by steps 121-127, step 129 of FIG. 3 is replaced with a step 145, and step 109 is implemented by a step 147 instead of by step 131.

Step 141 comprises determining a plurality of orders for reproducing the at least three songs and the at least three light scripts based on the differences determined in step 105. In step 141, only the orders are determined in which the differences between light settings specified in each pair of consecutive light scripts stay below a threshold. Step 143 comprises selecting one of the plurality of orders, e.g. by randomly selecting one of the orders determined in step 141.

Step 145 comprises adjusting at least one of the light scripts obtained in step 103 to reduce differences between one or more pairs of light scripts that are consecutive in the order selected in step 143. Step 147 comprises controlling the lighting device to render the light settings specified in the at least three light scripts according to the order, including the adjustments determined in step 145.

Adjusting a light script typically also changes the transition between this light script and the next light script. For example, for a color palette, colors may be selected for both songs that might not be a perfect fit but would result in less contrasting transition. Also, the total amount of colors used in a playlist can be limited. The color palette used in one song can resemble or use matching colors of other songs, thus creating more uniform light effects for the entire playlist.

Thus, after a new order has been determined in step 107, light effects for each song and for each transition may be created. Depending on the specific embodiment, light effects for each song could remain as if songs would be played in isolation and only the order and possibly the transitions are adjusted, as shown in FIG. 3, or specific songs light effects could also be adjusted, as shown in FIG. 4.

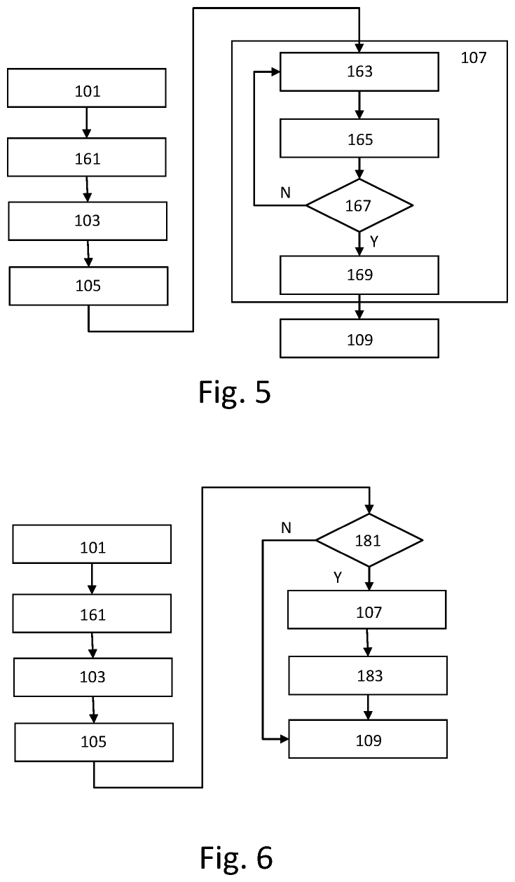

A third embodiment of the method of determining an order for reproducing light scripts is shown in FIG. 5. Step 101 comprises selecting at least three songs from a collection of songs. Step 161 comprises determining an initial order for reproducing the at least three songs. Step 103 comprises obtaining at least three light scripts for the at least three songs. Step 105 comprises performing an analysis on the light settings specified in the at least three light scripts to determine differences between the light settings specified in the at least three light scripts.

Next, step 107 comprises determining the order for reproducing the at least three songs and the at least three light scripts based on the differences. In the embodiment of FIG. 3, step 107 is implemented by steps 163-169. In the first iteration of step 1631, step 163 comprises determining a first candidate order for reproducing the at least three songs and the at least three light scripts. Step 165 comprises determining, based on the differences determined in step 105, how many consecutive pairs of songs of the initial order are included in the order determined in step 163.

Step 167 comprises determining whether all (suitable) candidate orders have been determined. If not, steps 163-167 are repeated for the next candidate order. If it is determined in step 167 that all (suitable) candidate orders have been determined, step 169 is performed next. Step 169 comprises selecting one of the orders determined in step 163 based on the quantities determined in step 123 to replace the initial order, and specifically comprises selecting the order with the largest quantity. The order selected in step 169 is thus based on the initial order.

Step 109 comprises controlling the lighting device to render the light settings specified in the at least three light scripts according to the order determined in step 107, communicating the order determined in step 107 to a further system, and/or storing the order determined in step 107 in a memory.

A fourth embodiment of the method of determining an order for reproducing light scripts is shown in FIG. 6. Step 101 comprises selecting at least three songs from a collection of songs. Step 161 comprises determining an initial order for reproducing the at least three songs. Step 103 comprises obtaining at least three light scripts for the at least three songs. Step 105 comprises performing an analysis on the light settings specified in the at least three light scripts to determine differences between the light settings specified in the at least three light scripts.

After step 105, a step 181 is performed. Step 181 comprises checking whether a shuffle mode is active. If it is determined in step 181 that a shuffle mode is active, steps 107 and 183 are performed. If it is determined in step 181 that a shuffle mode is not active, steps 107 and 183 are skipped and step 109 is performed next. Step 107 comprises determining the order for reproducing the at least three songs and the at least three light scripts based on the differences. Step 183 comprises replacing the initial order with the order determined in step 107.

Step 109 comprises controlling the lighting device to render the light settings specified in the at least three light scripts according to the determined order, communicating the determined order to a further system, and/or storing the determined order in a memory. If steps 107 and 183 have been performed, this determined order is the order determined in step 107. Otherwise, this determined order is the initial order determined in step 161.

The embodiment of FIG. 6 may be combined with the embodiment of FIG. 4. In this alternative embodiment, if the playback is set to shuffle, which means that user is not expecting a specific order of songs, the shuffling function is modified to take the light effect differences into account, but still have the aspect of randomness, such that when the same playlist is played on shuffle, the order is not exactly the same due to the requirement of limiting differences between light scripts. This option may be offered as a hybrid shuffle mode, for example.

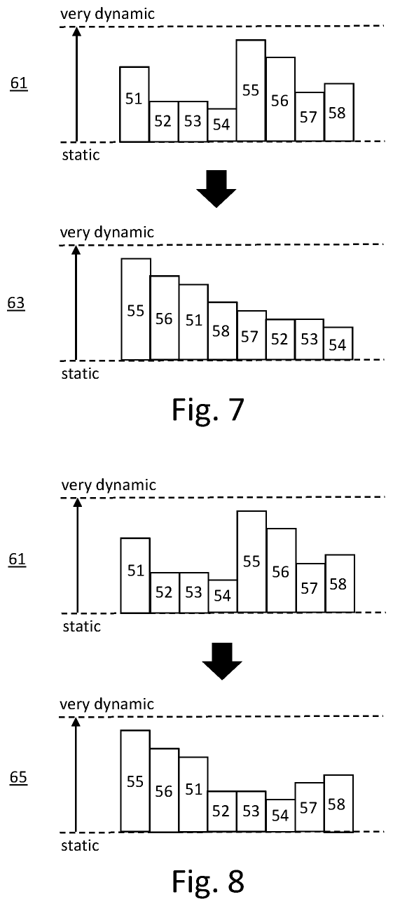

FIGS. 7 and 8 show examples in which is an initial order is replaced. In FIGS. 7 and 8, eight songs and eight associated light scripts 51-58 have been selected and have an initial order 61. The initial order 61 may be the order as used in an album (as released by an artist) or may be the order as used in a playlist of songs from different albums, for example. The latter playlist may be manually created by an author or generated automatically by a music streaming service, e.g. like Spotify's “Daily Mix”. In the examples of FIGS. 7 and 8, only the differences in dynamicity between the different light scripts are considered.

FIG. 7 shows a first example in which is an initial order is replaced using a combination of the methods of FIGS. 3 and 6. If the shuffle mode is active, a new order 63 is determined. In the example of FIG. 7, the order with the lowest sum of differences is selected, as described in relation to FIG. 3. When only the differences in dynamicity between the different light scripts are considered, this typically means that the light scripts (and therefore the songs) are ordered from very dynamic to static or from static to very dynamic. In order 63, the light scripts are ordered from very dynamic to static. The light script 55 has the most dynamic light settings of the light scripts 51-58 and the light script 54 has the least dynamic light settings of the light scripts 51-58. The complete order 63 of the light scripts is as follows: 55, 56, 51, 58, 57, 52, 53, and 54.

FIG. 8 shows a second example of replacing an initial order, this time using a combination of the methods of FIGS. 4 and 5. In the example of FIG. 8, a new order 65 is determined based on the initial order 61. The differences between light settings specified in each pair of consecutive light scripts stay below a threshold in order 65. For example, if dynamicity is expressed as a percentage, a predefined threshold of 30% could be used. This threshold may be increased if there is no order complying with this requirement, e.g. increased in small steps until an order is found which complies with this requirement. Transitions may be adapted/inserted to smoothen larger differences.

If multiple orders are found that comply with the requirement that all differences should stay below the threshold, an order is selected that is most similar to the initial order. In the embodiment of FIG. 5 and the example of FIG. 8, similarity is determined by determining how many consecutive pairs of songs a new order has in common with the initial order. In order 65, like in order 61, song 55 is followed by song 56, song 51 is followed by song 52, song 52 is followed by song 53, song 53 is followed by song 54, and song 57 is followed by song 58.

Order 65 therefore has five consecutive pairs in common with order 61. The complete order 65 of the light scripts is as follows: 55, 56, 51, 52, 53, 54, 57, and 58. Order 65 has more consecutive pairs in common with order 61 than other orders in which the differences stay below the threshold.

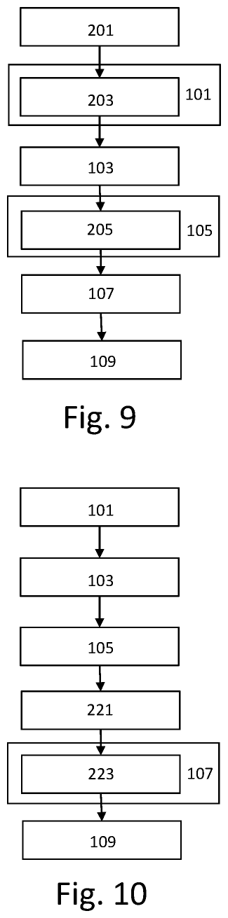

A fifth embodiment of the method of determining an order for reproducing light scripts is shown in FIG. 9. A step 201 comprises receiving user input indicating a desired range of dynamicity settings, a desired range of brightness settings and/or a desired range of color settings. Next, step 101 comprises selecting at least three songs from a collection of songs. In the embodiment of FIG. 9, step 101 is implemented by a step 203. Step 203 comprises selecting the at least three songs such that at least three light scripts can be obtained which have light settings falling in the one or more desired ranges.

Step 103 comprises obtaining at least three light scripts for the at least three songs selected in step 203. These light scripts have light settings which fall in the one or more desired ranges indicated in the user input received in step 201.

Step 105 comprises performing an analysis on the light settings specified in the at least three light scripts to determine differences between the light settings specified in the at least three light scripts. In the embodiment of FIG. 9, step 105 is implemented by a step 205. Step 205 comprises performing the analysis on dynamicity settings, brightness settings and/or color settings of the light settings specified in the at least three light scripts. Furthermore, step 205 comprises performing the analysis on the light settings specified in the at least three light scripts to determine differences between average light settings specified in the one of the at least three light scripts and average light settings specified in the another one of the at least three light scripts.

Next, step 107 comprises determining the order for reproducing the at least three songs and the at least three light scripts based on the differences. Step 109 comprises controlling the lighting device to render the light settings specified in the at least three light scripts according to the order, communicating the order to a further system, and/or storing the order in a memory.

With the method of FIG. 9, user defined settings may be taken into account when selecting songs, or in an alternative embodiment, when determining light effects to be rendered along with selected songs. As a first example, a user might fix a level of dynamicity or a color palette and then, the order of the songs is determined to limit or minimize differences in the values of the remaining parameters. Certain parameters like the color palette may alternatively be defined by the song. As a second example, a user might specify a desired range of dynamicity values, e.g. by choosing one of four dynamicity settings like “subtle” and “intense”. In this case, different songs can still have a variation in dynamics in their light scripts. As a third example, a user might specify a minimum or maximum brightness (e.g. maximum brightness of 75%).

A sixth embodiment of the method of determining an order for reproducing light scripts is shown in FIG. 10. Step 101 comprises selecting at least three songs from a collection of songs. Step 103 comprises obtaining at least three light scripts for the at least three songs. Step 105 comprises performing an analysis on the light settings specified in the at least three light scripts to determine differences between the light settings specified in the at least three light scripts.

Next, a step 221 comprises receiving user input indicating a desired pattern in dynamicity settings of the light scripts to be reproduced. Step 107 comprises determining the order for reproducing the at least three songs and the at least three light scripts based on the differences. In the embodiment of FIG. 10, step 107 is implemented by a step 223. Step 223 comprises determining an order that conforms with the pattern indicated in the user input received in step 211.

For example, the user may specify that the light scripts should be ordered from very dynamic to static, like order 63 of FIG. 8, or from static to very dynamic. The user may also be able to specify that the light scripts should start and end (relatively) static and be (relatively) dynamic in the middle of the playlist. In this case, a plurality of orders may be determined that conforms with this specified pattern and the one with the lowest sum of differences, as described in relation to FIG. 3, may be selected from this plurality of orders.

Alternatively, a plurality of orders may be determined that conforms with this specified pattern and in which the differences between the light scrips stay below a threshold, as described in relation to FIG. 4, and one of these orders may be selected randomly. Step 109 comprises controlling the lighting device to render the light settings specified in the at least three light scripts according to the order, communicating the order to a further system, and/or storing the order in a memory.

With the method of FIG. 10, it is possible to take into account a desired pattern in level of dynamicity over the full playlist when determining the order. For example, for a party, a user might want to start with songs with slower dynamic light effects to allow for socializing and as the party progresses have more dynamic songs and light effects to stimulate dancing. Similarly, for a romantic dinner and evening, the songs might be ordered in a descending dynamic level to increase the chances of a successful end of the romantic date. Other patterns may also be specified, e.g. “slower, faster, slower, faster”. A pattern may even be selected based on planned activities, e.g. a higher brightness and cooler colors when the workday starts and ends and dimmed brightness and warmer colors at lunch time.

The embodiments of FIGS. 3 to 6 and 9 to 10 differ from each other in multiple aspects, i.e. multiple steps have been added or replaced. In variations on these embodiments, only a subset of these steps is added or replaced and/or one or more steps is omitted. As a first example, step 205 may be omitted from the embodiment of FIG. 9 and/or added to the embodiments of any of FIGS. 3 to 6 and 10. As a second example, steps 129 and 131 may be omitted from the embodiment of FIG. 3 and/or added to any of the embodiments of FIGS. 4 to 6 and 9 to 10. As a third example, steps 145 and 147 may be omitted from the embodiment of FIG. 4 and/or added to any of the embodiments of FIGS. 3, 5 to 6, and 9 to 10. As a fourth example, the embodiments of FIG. 9 and/or FIG. 10 may be combined with any of the embodiments of FIGS. 3 to 6. As a fifth example, the embodiment of FIG. 5 and/or the embodiment of FIG. 6 may be combined with any of the embodiments of FIGS. 3 to 4.

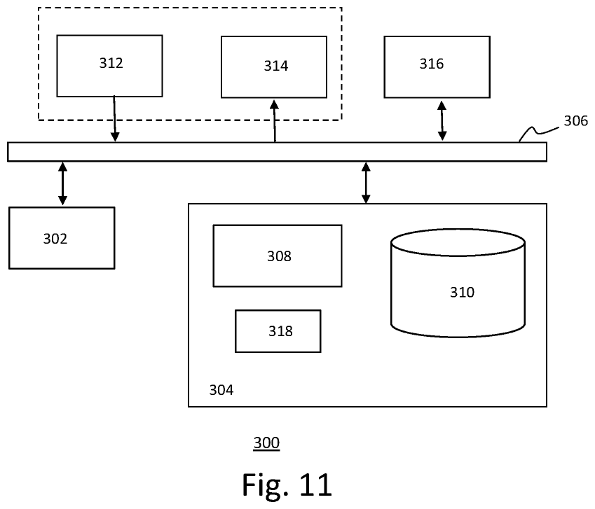

FIG. 11 depicts a block diagram illustrating an exemplary data processing system that may perform the method as described with reference to FIGS. 3 to 6 and 9 to 10.

As shown in FIG. 11, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification. The data processing system may be an Internet/cloud server, for example.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 11 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 11, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 11) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for determining an order for reproducing light scripts, said system comprising at least one processor configured to:
select at least three songs from a collection of songs,
obtain at least three light scripts for said at least three songs,
determine differences between said at least three light scripts by determining differences between light settings specified in said at least three light scripts,
determine said order for reproducing said at least three songs and said at least three light scripts based on said differences such that said differences between light scripts of consecutive songs are limited or minimized, and
control a lighting device to render said light settings specified in said at least three light scripts according to said order, communicate said order to a further system, and/or store said order in a memory.

2. A system as claimed in claim 1, wherein said at least one processor is configured to determine a transition between two of said at least three light scripts and control said lighting device to render said transition between said two light scripts, said two light scripts being ordered consecutively in said order.

3. A system as claimed in claim 1, wherein said at least one processor is configured to adjust at least one of two of said at least three light scripts to reduce differences between said two light scripts, said two light scripts being ordered consecutively in said order.

4. A system as claimed in claim 1, wherein said at least one processor is configured to determine a plurality of orders for reproducing said at least three songs and said at least three light scripts, determine for each of said plurality of orders a sum of differences between each pair of consecutive light scripts in said respective order, and select an order with from said plurality of orders based on said sums.

5. A system as claimed in claim 1, wherein said at least one processor is configured to determine a plurality of orders for reproducing said at least three songs and said at least three light scripts, differences between each pair of consecutive light scripts staying below a threshold in each of said plurality of orders, and selecting one of said plurality of orders.

6. A system as claimed in claim 1, wherein said at least one processor is configured to determine an initial order for reproducing said at least three songs and replace said initial order with said order.

7. A system as claimed in claim 6, wherein said at least one processor is configured to determine said order for reproducing said at least three songs and said at least three light scripts further based on said initial order.

8. A system as claimed in claim 7, wherein said at least one processor is configured to determine a plurality of orders for reproducing said at least three songs and said at least three light scripts, determine for each of said plurality of orders a quantity of consecutive pairs of songs of said initial order included in said respective order, and select an order from said plurality of orders based on said quantities.

9. A system as claimed in claim 1, wherein said at least one processor is configured to determine said order for reproducing said at least three songs and said at least three light scripts in dependence on a shuffle mode being active.

10. A system as claimed in claim 1, wherein said at least one processor is configured to determine said differences by performing an analysis on dynamicity settings, brightness settings and/or color settings of said light settings specified in said at least three light scripts.

11. A system as claimed in claim 1, wherein said at least one processor is configured to receive user input indicating a desired range of dynamicity settings, a desired range of brightness settings and/or a desired range of color settings, said at least three light scripts having light settings falling in said one or more desired ranges, and/or user input indicating a pattern in dynamicity settings, said order conforming with said specified pattern.

12. A system as claimed in claim 1, wherein said at least one processor is configured to determine said differences by determining differences between average light settings specified in said at least three light scripts.

13. A method of determining an order for reproducing light scripts, said method comprising, by at least one processor;
selecting at least three songs from a collection of songs;
obtaining at least three light scripts for said at least three songs;
determining differences between said at least three light scripts by determining differences between light settings specified in said at least three light scripts;
determining said order for reproducing said at least three songs and said at least three light scripts based on said differences such that said differences between light scripts of consecutive songs are limited or minimized; and
controlling a lighting device to render said light settings specified in said at least three light scripts according to said order, communicating said order to a further system, and/or storing said order in a memory.

14. A computer program product for a computing device, the computer program product comprising computer program code to perform the method of claim 13 when the computer program product is run on a processing unit of the computing device.
